(19) United States
(12) Patent Application Publication
(10) Pub. No.: US 2024/0104453 A1
(43) Pub. Date: Mar. 28, 2024

(54) System and Method for Dynamic Pairing of a Device and an Individual

(71) Applicant: ZEBRA TECHNOLOGIES CORPORATION, Lincolnshire, IL (US)

(72) Inventors: Matthew Louis Kowalski, Merrick, NY (US); Andrew Ehlers, Elmhurst, IL (US); Seth David Silk, Barrington, IL (US)

(21) Appl. No.: 17/955,314

(22) Filed: Sep. 28, 2022

(51) Int. Cl. G06Q 10/06; G05D 1/02

(52) U.S. Cl. CPC G06Q 10/063112; G05D 1/0276; G05D 1/0287

(57) ABSTRACT

Systems and methods for pairing a device and an individual are provided. The system receives first task data indicative of a first set of tasks to be executed by an individual among one or more individuals, device data indicative of identification information of a device, and data of the one or more individuals. The system selects at least one attribute of the data of the one or more individuals and weights the selected at least one selected attribute. The system determines a profile and a profile value for each of the one or more individuals based on the weighted at least one attribute of the data of the one or more individuals, and pairs the first task data and the device with a first individual from among the one or more individuals based on the determined profile value for each of the one or more individuals.

### BACKGROUND

In a facility (e.g., a warehouse and/or distribution center), storing items for shipment can utilize a workflow management system (WMS) to monitor and manage the execution and completion of various workflows (e.g., a set of tasks) by a device (e.g., a robot such as an autonomous mobile robot (AMR) or a drone such as an unmanned aerial vehicle (UAV)) and/or an individual (e.g., a human worker) within the facility. For example, a robot can assist a worker with various tasks related to order fulfillment such as locating, picking, and retrieving an ordered item from shelving rows of a facility. Conventional workflow management systems utilize static one-to-one pairing of a robot and worker to execute and complete various workflows. However, these systems cannot dynamically pair a robot and worker based on robot deployment conditions (e.g., worker to robot availability) and/or worker attributes. For example, these systems cannot dynamically pair a robot and a worker based on when a number of available workers is greater than a number of available robots and/or a particular robot and worker pairing is required to execute and complete a workflow based on one or more attributes of a worker in relation to the workflow.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating an embodiment of the system of the present disclosure.

FIGS. 2A-B are diagrams illustrating execution of a workflow by a paired worker and robot.

FIG. 3 is a flowchart illustrating processing steps carried out by the system of the present disclosure.

FIGS. 4A-B are graphs illustrating worker profiles based on one or more attributes of each worker as determined in step 208 of FIG. 3.

FIG. 5 is a diagram illustrating an embodiment of the system of the present disclosure including an implementation of training a model and/or utilized a trained model described herein.

FIG. 6 is a flowchart illustrating processing steps in relation to FIG. 5.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a system for pairing a device and an individual comprising a memory configured to store computer executable instructions and a processor configured to interface with the memory and execute the computer executable instructions to cause the processor to receive first task data indicative of a first set of tasks to be executed by an individual among one or more individuals, device data indicative of identification information of a device, and data of the one or more individuals, select at least one attribute of the data of the one or more individuals, weight the selected at least one attribute of the data of the one or more individuals, determine a profile and a profile value for each of the one or more individuals based on the weighted at least one attribute of the data of the one or more individuals, and pair the first task data and the device with a first individual from among the one or more individuals based on the determined profile value for each of the one or more individuals.

Additional examples disclosed herein are directed to a method for pairing a device and an individual comprising receiving first task data indicative of a first set of tasks to be executed by an individual among one or more individuals, device data indicative of identification information of a device, and data of the one or more individuals; selecting at least one attribute of the data of the one or more individuals; weighting the selected at least one attribute of the data of the one or more individuals; determining a profile and a profile value for each of the one or more individuals based on the weighted at least one attribute of the data of the one or more individuals; and pairing the first task data and the device with a first individual from among the one or more individuals based on the determined profile value for each of the one or more individuals.

Additional examples disclosed herein are directed to a non-transitory computer readable medium having instructions stored thereon for pairing a device and an individual which, when executed by a processor, causes the processor to carry out the steps of receiving first task data indicative of a first set of tasks to be executed by an individual among one or more individuals, device data indicative of identification information of a device, and data of the one or more individuals; selecting at least one attribute of the data of the one or more individuals; weighting the selected at least one attribute of the data of the one or more individuals; determining a profile and a profile value for each of the one or more individuals based on the weighted at least one attribute of the data of the one or more individuals; and pairing the first task data and the device with a first individual from among the one or more individuals based on the determined profile value for each of the one or more individuals.

As mentioned above, conventional workflow management systems utilize static one-to-one pairing of a device (e.g., a robot such as an autonomous mobile robot (AMR) or a drone such as an unmanned aerial vehicle (UAV)) and/or an individual (e.g., a human worker) to execute and complete various workflows. As such, conventional workflow management systems suffer from a general lack of versatility because these systems cannot dynamically pair a robot and a worker to execute and complete various workflows based on robot deployment conditions (e.g., worker to robot availability) and/or worker attributes. For example, these systems cannot dynamically pair a robot and a worker based on when a number of available workers is greater than a number of available robots and/or a particular robot and worker pairing is required to execute and complete a workflow based on one or more attributes of a worker in relation to the workflow.

Overall, this lack of versatility causes conventional workflow management systems to provide inefficient and underwhelming performance, reduce the efficiency and general timeliness of workflow execution and completion, and create an unsavory worker experience.

Thus, it is an objective of the present disclosure to eliminate these and other problems with conventional workflow management systems via systems and methods that can dynamically pair a robot and a worker to execute and complete various workflows based on robot deployment conditions (e.g., worker to robot availability) and/or worker attributes. For example, the systems and methods of the present disclosure alleviate the issues present with conventional systems by dynamically pairing a robot and a worker when a number of available workers is greater than a number of available robots and/or a particular robot and worker pairing is required to execute and complete a workflow based on one or more attributes of a worker in relation to the workflow.

In accordance with the above, and with the disclosure herein, the present disclosure includes improvements in computer functionality or in improvements to other technologies at least because the present disclosure describes that, e.g., workflow management systems, and their related various components, may be improved or enhanced with the disclosed dynamic system features and methods that provide more safe and efficient working conditions for workers and improved monitoring and management of workflows for system administrators. That is, the present disclosure describes improvements in the functioning of a workflow management system itself or “any other technology or technical field” (e.g., the field of distributed/commercial/industrial information systems) because the disclosed dynamic system features and methods improve and enhance the deployment and operation of each robot and the experience of each worker by introducing dynamic pairing of a robot and worker to mitigate worker fatigue and eliminate inefficiencies typically experienced over time by workflow management systems lacking such features and methods. This improves the state of the art at least because such previous workflow management systems are inefficient as they lack the ability to dynamically pair a robot and a worker when a number of available workers is greater than a number of available robots and/or a particular robot and worker pairing is required to execute and complete a workflow based on one or more attributes of a worker in relation to the workflow.

In addition, the present disclosure includes applying various features and functionality, as described herein, with, or by use of, a particular machine, e.g., a processor, a mobile device, a receiver device (e.g., a worker wearable device and/or robot), and/or other hardware components as described herein.

Moreover, the present disclosure includes specific features other than what is well-understood, routine, conventional activity in the field, or adding unconventional steps that demonstrate, in various embodiments, particular useful applications, e.g., training a machine learning model and/or utilizing a trained machine learning model in connection with learning and identifying attributes of one or more workers to dynamically pair a workflow and robot with a worker. The machine learning model training and utilization described herein may be performed using a machine learning system. The machine learning system may include or may be included in a computing device, a server, a cloud computing environment, or the like, such as the system of the present disclosure, as described in more detail elsewhere herein.

Accordingly, it would be highly beneficial to develop a system and method that can dynamically pair a robot and a worker to execute and complete various workflows when a number of available workers is greater than a number of available robots and/or a particular robot and worker pairing is required to execute and complete a workflow based on one or more attributes of a worker in relation to the workflow. The systems and methods of the present disclosure address these and other needs.

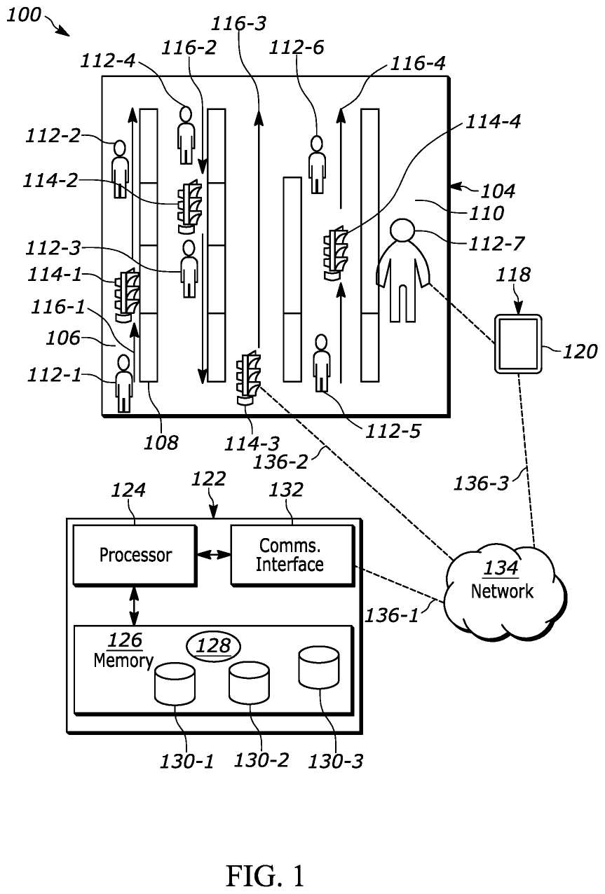

Turning to the drawings, FIG. 1 is a diagram illustrating an embodiment of the system 100 of the present disclosure. FIG. 1 illustrates a system 100 deployed in a facility 104 (e.g., a warehouse or distribution facility depicted from overhead) containing items (not shown) disposed on shelving of rows 108. As shown in FIG. 1, the facility 104 includes a plurality of aisles 106 and a plurality of rows 108 (e.g., of shelving racks) in a floor area 110. The rows 108 support a variety of items for shipment from the facility 104. It should be understood that the facility 104 can be a retail facility containing items disposed on racks, shelving, or the like where the rows 108 in the floor area 110 (e.g. of shelving racks, peg boards, clothes hangers, or the like) support a variety of items for purchase by customers of the facility 104.

The system 100 performs dynamic pairing of one or more individuals 112-1, 112-2, 112-3, 112-4, 112-5, 112-6, and 112-7 (collectively referred to as individuals or workers 112) and one or more robots 114-1, 114-2, 114-3, and 114-4 (collectively referred to as robots 114) such that a robot 114 can assist a worker 112 to execute and complete a workflow (e.g., a set of tasks) as described in further detail below. As shown in FIG. 1, the system 100 can dynamically pair a worker 112 and a robot 114 when a number of available workers 112 is greater than a number of available robots 114 based on one or more attributes of the worker 112 in relation to a workflow. The system 100 can also dynamically pair a worker 112 and a robot 114 when a particular worker 112 and robot 114 pairing is required to execute and complete a workflow based on one or more attributes of a worker 112 in relation to the workflow.

A robot 114 can include, but is not limited to, an autonomous mobile robot (AMR) and an unmanned aerial vehicle (UAV) such as a drone. A robot 114 can move autonomously about aisles 106 of the floor area 110 along paths 116-1, 116-2, 116-3 and 116-4 (collectively referred to as the paths 116) to assist a worker 112 with which it is paired in executing and completing a set of tasks within the facility 104. For example, the robot 114-1 can be paired with the worker 112-1 and can move up and down aisles 106 of a floor area 110 of the facility 104 along path 116-1 to assist the worker 112-1 in executing and completing a set of tasks related to order fulfillment such as locating, picking and retrieving ordered items 150 (not shown) from the rows 108. The robot 114 can lead or follow the worker 112 when assisting the worker 112 in executing and completing a set of tasks. The robot 114 can also move to a location where the worker 112 is present or to one or more locations of respective items to be picked by the worker 112 when assisting the worker 112 in executing and completing a set of tasks.

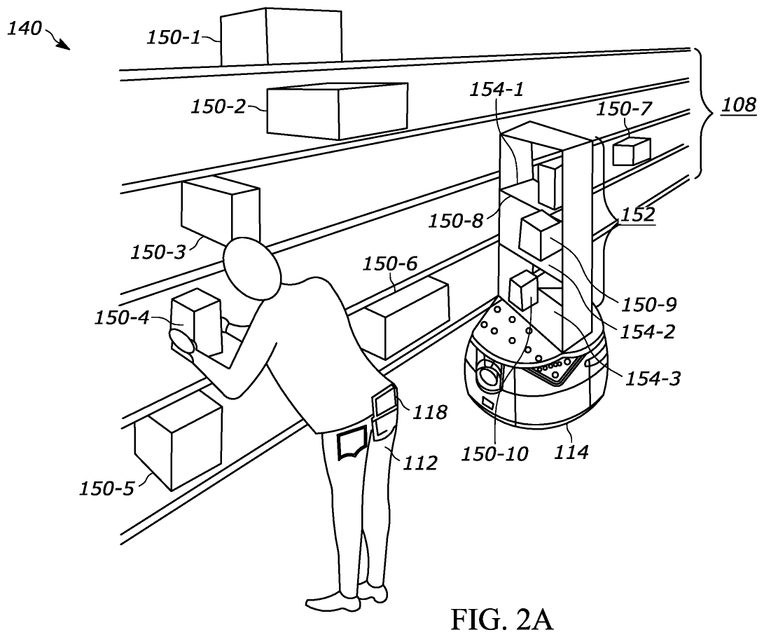

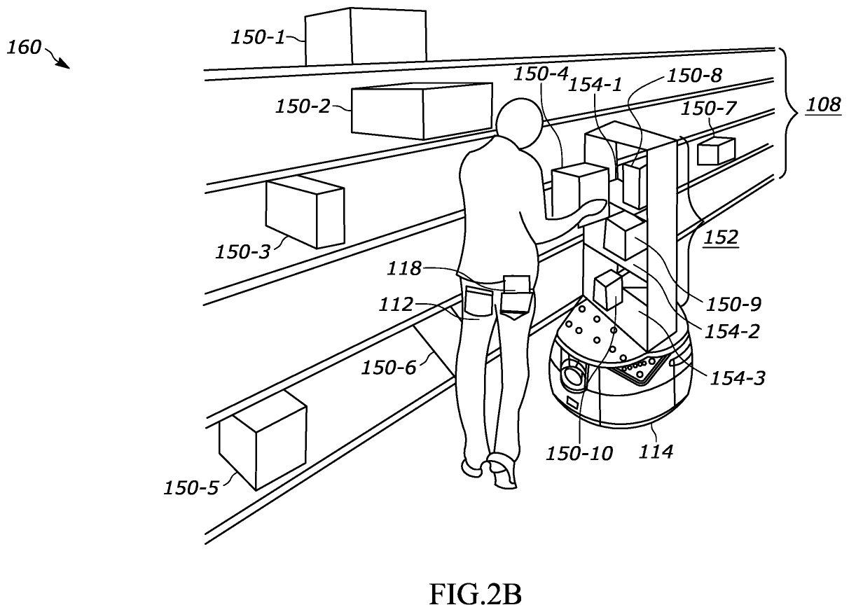

FIGS. 2A and 2B are diagrams 140, 160 illustrating execution of a workflow by a paired worker 112 and robot 114. As shown in FIGS. 2A and 2B, a worker can select an item 150-4 from among a plurality of items 150-1, 150-2, 150-3, 150-4, 150-5, 150-6, 150-7, 150-8, 150-9 and 150-10 (collectively referred to as items 150) positioned on shelving of a row 108 for storage on the robot 114. The robot 114 can include a storage area 152 comprising shelves 154-1, 154-2 and 154-3 (collectively referred to as shelves 154) for storing items 150 (e.g., items 150-8, 150-9 and 150-10) selected (e.g., picked) by the worker 112 from the shelving of the row 108. It should be understood that the storage area 152 can also comprise bins or trays or any suitable combination of bins, trays and shelves 154. The worker 112 can view the workflow on a display of a mobile device 118 (e.g., a smartphone, tablet, or mobile computer).

Referring back to FIG. 1, the system 100 also includes a computing device 122 (e.g., a server) in communication with the robots 114 and the mobile device 118 (e.g., a smartphone, tablet, or mobile computer) of a worker 112 via a network 134 (e.g., a wired or wireless access point). For example, the computing device 122 can be in communication with the robots 114 and the mobile device 118 via communication links 136-1, 136-2 and 136-3.

The computing device 122 includes a processor 124 (e.g., a controller) in communication with a memory 126 (e.g., a non-transitory computer readable storage medium). The memory 126 can include a combination of volatile memory (e.g., Random Access Memory (RAM)) and non-volatile memory (e.g., read only memory (ROM), Electrically Erasable Programmable Read Only Memory (EEPROM), flash memory, etc.). The processor 124 and the memory 126 each comprise one or more integrated circuits. The computing device 122 also includes a communications interface 132 such that the computing device 122 can exchange data with other devices, including the robots 114 and the mobile device 118 via the network 138.

The memory 126 stores computer readable instructions for execution by the processor 124. In particular, the memory 126 stores code 128 (e.g., an application) which, when executed by the processor 124, configures the processor 124 to dynamically pair a workflow and a robot 114 with a worker 112. For example, the processor 124 can be configured to receive task data indicative of a workflow (e.g., a set of tasks) to be executed by a worker 112 among one or more workers 112, device data indicative of identification information of a robot 114, and data of the one or more workers 112; select at least one attribute of the data of the one or more workers 112; weight the selected at least one attribute of the data of the one or more workers 112; determine a profile and a profile value for each of the one or more workers 112 based on the weighted at least one attribute; and pair the workflow and the robot 114 with a worker 112 from among the one or more workers 112 based on the determined profile value for each of the one or more workers 112. In this way, the processor 124 can dynamically pair a worker 112 and a robot 114 when a number of available workers 112 is greater than a number of available robots 114 based on one or more attributes of the worker 112 in relation to a workflow. Additionally, the processor can dynamically pair a worker 112 and a robot 114 when a particular worker 112 and robot 114 pairing is required to execute a workflow based on one or more attributes of a worker 112 in relation to the workflow.

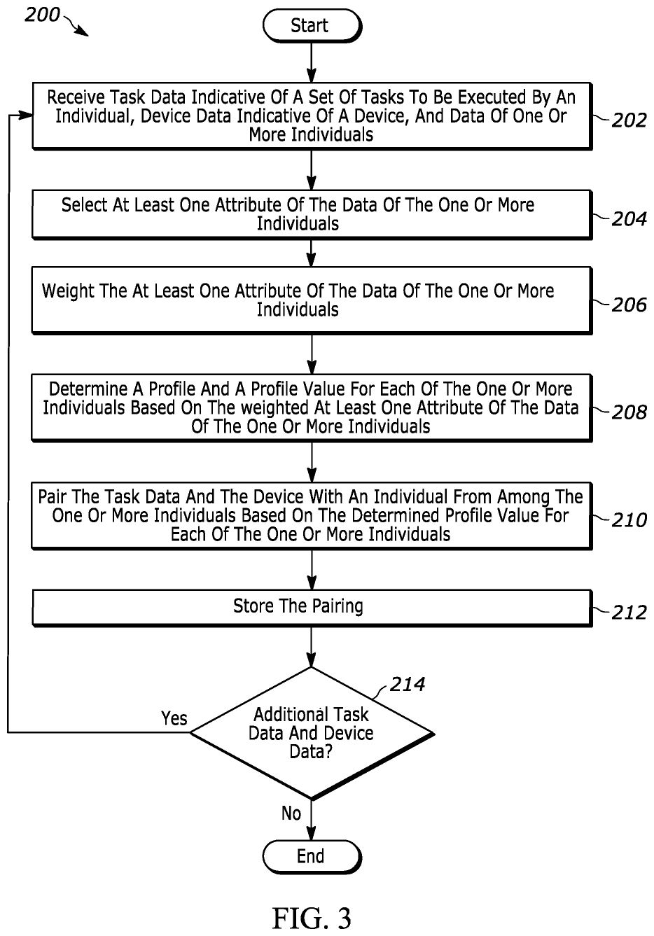

The pairing of the workflow and the robot 114 with the worker 112 may be transmitted to and stored in the memory 126 and/or transmitted to other computing devices such as the mobile device 118 as described in further detail below in relation to FIGS. 3-6. For example, the system 100 can provide feedback, autonomously and in real-time, to a worker 112 or a system administrator during and after effecting the pairing. As mentioned above, a worker 112 can carry or otherwise access a mobile device 118 (e.g., a smartphone, tablet, or mobile computer). The feedback data can be displayed via an output assembly of the mobile device 118, such as a display 120. The feedback data can indicate at least one pairing of a workflow and robot 114 with a worker 112 and reasoning for such pairing (e.g., a display, such as worker profile, indicative of on one or more attributes of the worker 112 in relation to a workflow to be executed and completed by the worker 112 and robot 114).

The code 128 could be programmed using any suitable programming languages including, but not limited to, C, C++, C#, Java, or any other suitable language. Additionally, the code 128 could be distributed across multiple computer systems in communication with each other over a communications network, stored within hardware, and/or stored and executed on a cloud computing platform and remotely accessed by a computer system in communication with the cloud platform. The code 128, executed by the processor 124, could communicate with databases 130-1, 130-2 and 130-3, which could be stored on the same computer system as the code 128, or on one or more other computer systems in communication with the code 128.

As shown in FIG. 1, the computing device 132 stores in the memory 126, the databases 130-1, 130-2, 130-3 (collectively referred to as the databases 130). The database 130-1 can contain one or more workflows to be executed and completed by a paired worker 112 and robot 114. As mentioned above, a workflow can comprise a set of tasks related to order fulfillment such as locating, picking and retrieving an ordered item from the rows 108 of the facility 104. For example, a set of tasks can comprise a list of ordered items to be located, picked and retrieved from the rows 108 of the facility 104. Each workflow can have one or more parameters which can impact and degrade a performance of a worker 112 executing the workflow due to fatigue. For example, a workflow can require changes in ambient environmental temperature (e.g., moving in and out of a cold room such as a refrigerator or freezer), extended periods in a non-climate-controlled work environment (e.g., a cold or hot work environment), changes in elevation (e.g., navigating stairs), energy expenditure (e.g., picking heavier or lighter items). The processor can arbitrarily receive a workflow from the database 130-1 or can request a workflow based on one or more parameters thereof and/or an order of priority. As such, the processor 124 can dynamically pair a worker 112 and a robot 114 when a particular worker 112 and robot 114 pairing is required to execute a workflow based on one or more attributes of a worker 112 in relation to the workflow.

The database 130-2 can contain device data indicative of identification information of one or more robots 114 including, but not limited to, a name, an IP address, a serial and/or model number, a battery charge level, a status (e.g., paired or unpaired) and/or other similar type of information.

The database 130-3 can contain data indicative of one or more workers 112 and attributes thereof. The attributes can include one or more of a route distance of one or more executed sets of tasks by a worker 112, a total distance traveled during a predetermined time period (e.g., a work shift) by a worker 112, an average speed of a worker 112, a number of executed and completed sets of tasks by a worker 112 during a predetermined time period (e.g., a workload capacity), a number of rest periods utilized by a worker 112 during a predetermined time period, an elevation change navigated by a worker 112, a work environment of a worker 112, and an energy expenditure associated with set of tasks (e.g., picking heavier or lighter items) executed and completed by a worker 112.

Those skilled in the art will appreciate that the functionality implemented by the processor 124 via the execution of the code 128 may also be implemented by one or more specially designed hardware and firmware components such as a field-programmable gate array (“FPGA”), application-specific integrated circuit (“ASIC”), embedded system, or other customized hardware components without departing from the spirit or scope of the present disclosure. FIG. 1 is only one potential configuration, and the system 100 of the present disclosure can be implemented using a number of different configurations.

FIG. 3 is a flowchart illustrating processing steps 200 carried out by the system 100 of the present disclosure. Beginning in step 202, the system 100 receives task data indicative of a set of tasks to be executed by a worker 112 from the database 130-1, device data indicative of information of a robot 114 from the database 130-2, and data of one or more workers 112 from the database 130-3.

In step 204, the system 100 selects at least one attribute of the data of the one or more workers 112. As mentioned above, an attribute can include one or more of a route distance of one or more executed and completed sets of tasks by a worker 112, a total distance traveled during a predetermined time period by a worker 112, an average speed of a worker 112, a number of executed and completed sets of tasks by a worker 112 during a predetermined time period (e.g., a workload capacity), a number of rest periods utilized by a worker 112 during a predetermined time period, an elevation change navigated by a worker 112, a work environment of a worker 112, and an energy expenditure associated with set of tasks (e.g., picking heavier or lighter items) executed and completed by the worker 112.

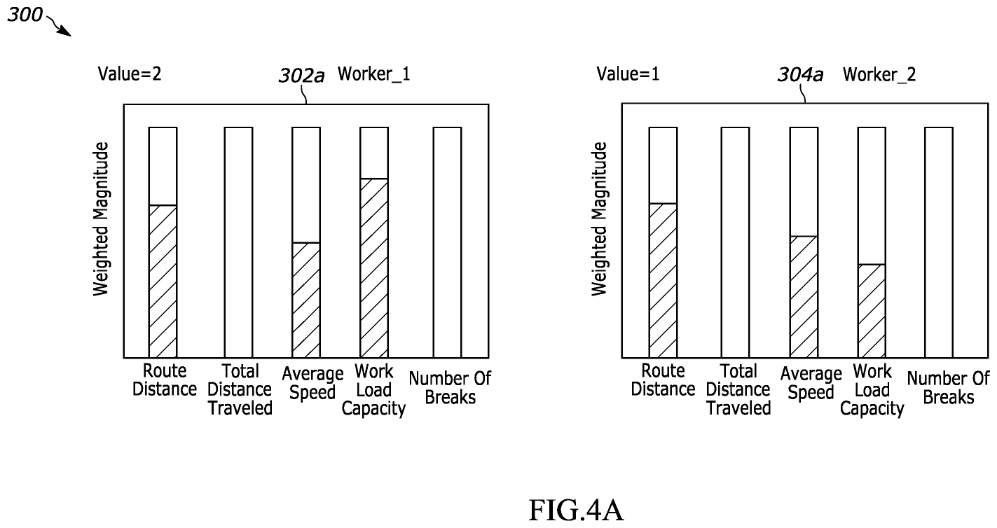

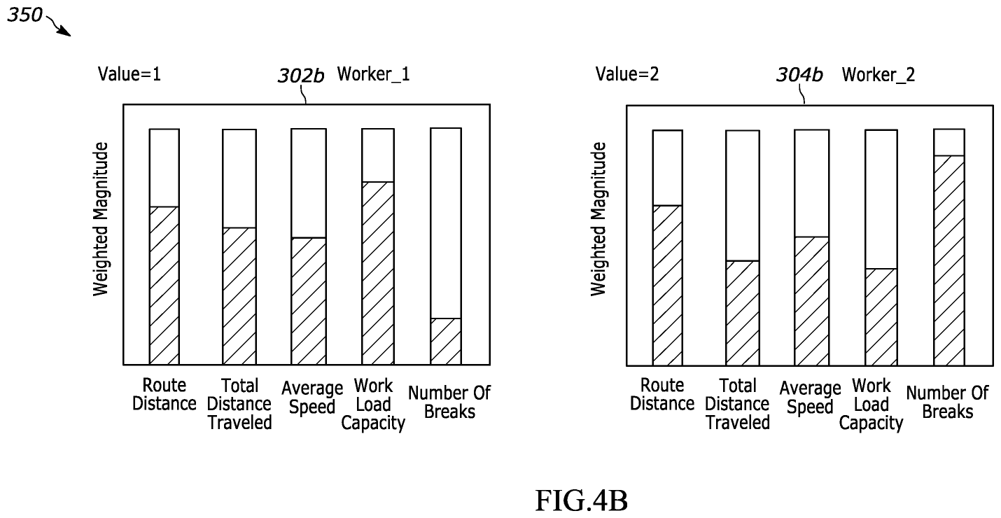

Next, in step 206, the system 100 weights the at least one attribute of the data of the one or more workers 112 based on a weighting coefficient. The weighting coefficient can be predetermined and can be fixed or variable. Then, in step 208, the system 100 determines a profile and a profile value for each of the one or more workers 112 based on the weighted at least one attribute of the data of the one or more workers 112. For example, FIG. 4A illustrates worker profiles 300 based on one or more attributes of each worker 112 (as determined in step 208 of FIG. 3) at a commencement of a predetermined time period (e.g., a work shift).

As shown in FIG. 4A, the worker profile 302a is associated with a first worker (e.g., Worker_1) and the worker profile 304a is associated with a second worker (e.g., Worker_2). The worker profiles 302a and 304a include several weighted attributes including a route distance of one or more executed and completed sets of tasks by a worker 112 (e.g., route distance), a total distance traveled during a predetermined time period (e.g., a work shift) by a worker 112 (e.g., total distance traveled), an average speed of a worker 112 (e.g., average speed), a number of executed and completed sets of tasks by a worker 112 during a predetermined time period (e.g., a workload capacity), and a number of rest periods utilized by a worker 112 during a predetermined time period (e.g., number of breaks). The system 100 can determine a worker profile for each worker 112 prior to a commencement of a work shift. As such, one or more weighted attributes may not have an associated score and one or more weighted attributes may have an associated score based on historical data. For example, each of the worker profiles 302a and 304a do not have a score associated with the total distance traveled weighted attribute and the number of breaks weighted attribute. Conversely, each of the worker profiles 302a and 304a have a score associated with the route distance, average speed and work load capacity weighted attributes.

As mentioned above, the system 100 can also determine a profile value for each profile of the one or more workers 112. The system 100 can determine the profile value according to Equation 1 below:

$$min ( {Score}_{{Worker}_{i}} ) = {\sum }_{i = 1}^{n} {β}_{i} {x}_{i} \qquad Equation 1$$

where i is an integer value, n is a number of independent variables, A is a weighted coefficient, and x, is an attribute of a worker 112 such that Equation 1 yields a lowest score for each worker 112.

Referring back to FIG. 3, in step 210, the system 100 pairs the received task data from the database 130-1 indicative of a set of tasks to be executed by a worker 112 and the received device data from the database 130-2 indicative of information of a robot 114 with a worker 112 from among the one or more workers 112 based on the determined profile value for each of the one or more workers 112. In particular, the system 100 can pair the task data and the robot 114 with a worker 112 having a lowest profile value among the one or more workers 112.

For example and as shown in FIG. 4A, the system 100 can pair task data and a robot 114 with the second worker (e.g., Worker_2) because the second worker has a profile value of 1 which is lower than the first worker (e.g., Worker_1) profile value of 2. In comparing the first worker profile 302a and the second worker profile 304a, each of the first and second workers have the same route distance score and average speed score but the first worker has a greater work load capacity score than the second worker. As such, the second worker may have less stamina during a work shift to execute and complete a workflow. Accordingly, to mitigate fatigue of the second worker, the system 100 dynamically pairs the workflow and robot 114 with the second worker.

Referring back to FIG. 3, in step 212, the system 100 stores the pairing. Then, in step 214, the system 100 determines whether there is additional task data and device data (e.g. an available robot 114) that can be paired with another worker 112 from among the one or more workers 112. If the system 100 determines that there is additional task data and device data, then the process returns to step 202. Alternatively, if the system 100 determines that there is not additional task data and device data, then the process ends.

FIG. 4B illustrates worker profiles 350 based on one or more attributes of each worker 112 (as determined in step 208 of FIG. 3) during a predetermined time period (e.g., a work shift). As shown in FIG. 4B, the worker profile 302b is associated with a first worker (e.g., Worker_1) and the worker profile 304b is associated with a second worker (e.g., Worker_2). The worker profiles 302b and 304b include several weighted attributes including a route distance of one or more executed and completed sets of tasks by a worker 112 (e.g., route distance), a total distance traveled during a predetermined time period (e.g., a work shift) by a worker 112 (e.g., total distance traveled), an average speed of a worker 112 (e.g., average speed), a number of executed and completed sets of tasks by a worker 112 during a predetermined time period (e.g., a workload capacity), and a number of rest periods utilized by a worker 112 during a predetermined time period (e.g., a number of breaks). During a work shift, scores of one or more weighted attributes may change. For example, in comparing the profiles 302a and 302b of the first worker, the score of each of the total distance traveled and the number of breaks has increased during a shift. Similarly, in comparing the profiles 304a and 304b of the second worker, the score of each of the total distance traveled and the number of breaks has increased during a shift. Accordingly, the system 100 can update a profile value for each worker 112 during a work shift and pair a workflow and a robot 114 based on the updated profile value for each worker 112.

For example and as shown in FIG. 4B, the system 100 can pair task data and a robot 114 with the first worker (e.g., Worker_1) because the first worker has a profile value of 1 which is lower than the second worker (e.g., Worker_2) profile value of 2. In comparing the first worker profile 302b and the second worker profile 304b, each of the first and second workers have the same route distance score and average speed score but the first worker has a greater work load capacity score than the second worker and a lower number of breaks score than the second worker. As such, it can be deduced that the first worker is executing and completing more workflows with a fewer number of breaks than the second worker. Accordingly, to mitigate fatigue of the first worker, the system 100 dynamically pairs the workflow and robot 114 with the first worker.

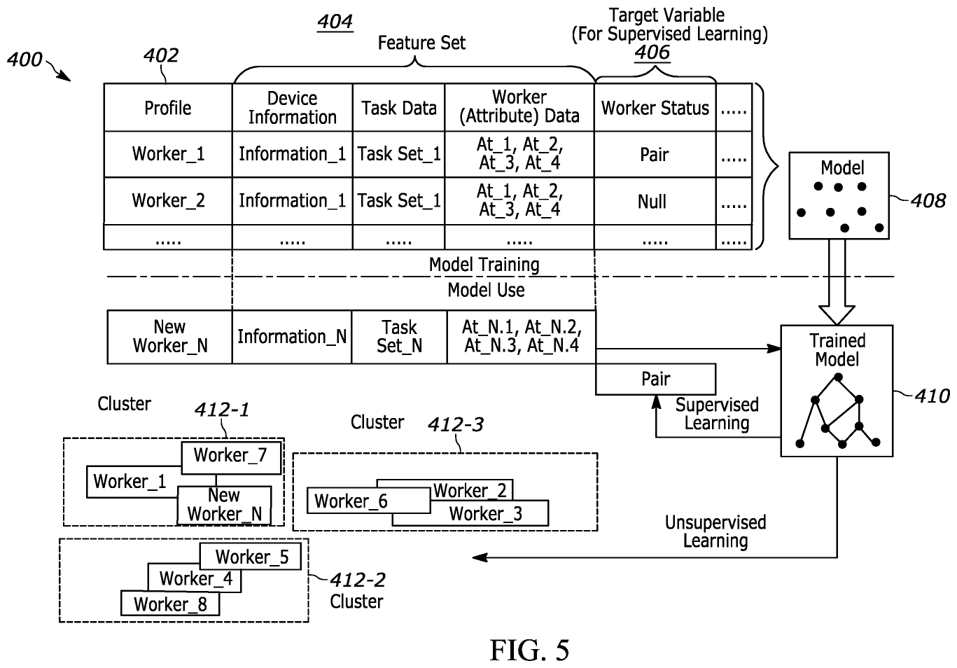

FIG. 5 is a diagram illustrating an embodiment of the system of the present disclosure including an implementation of training a model and/or using a trained machine learning model in connection with learning and identifying attributes of one or more workers 112 to dynamically pair a workflow and robot 114 with a worker 112 among the one or more workers 112. The machine learning model training and usage described herein may be performed using a machine learning system. The machine learning system may include or may be included in a computing device, a server, a cloud computing environment, or the like, such as the system 100, as described in more detail elsewhere herein.

As shown in FIG. 5, a machine learning model may be trained using a set of worker profiles 402. The set of worker profiles 402 may be obtained from training data (e.g., historical data), such as data gathered during one or more processes described herein. In some implementations, the machine learning system may receive the set of worker profiles 402 (e.g., as an input) from the computing device 122, the mobile device 118 or any other suitable device (e.g., a database or an IoT device).

The set of worker profiles 402 includes a feature set 404. The feature 404 set may include a set of variables, and a variable may be referred to as a feature. A specific worker profile may include a set of variable values (or feature values) corresponding to the set of variables. In some implementations, the machine learning system may determine variables for a set of worker profiles and/or variable values for a specific worker profile based on input received from the computing device 122, the mobile device 118, or any other suitable device. (e.g., an IoT device). For example, the machine learning system may identify a feature set (e.g., one or more features and/or feature values) by extracting the feature set from structured data, by performing natural language processing to extract the feature set from unstructured data, and/or by receiving input from a system administrator.

As an example, a feature set for a respective worker profile may include a first feature of device information of a robot 114 (e.g., identifying information, such as a name, an IP address, a serial and/or model number, and/or another similar type of information), a second feature based on task data (e.g., information of a set of tasks, such as a list of items to be located, picked and retrieved within a facility 104), a third feature of data of a worker 112 (e.g., at least one attribute of a worker 112), and so on. As shown, for a profile of Worker_1, the first feature may have a value of Information_1 (e.g., identifying a robot 114), the second feature may have a value of Task Set_1 (e.g., identifying a set of tasks), the third feature may have a value of At_1, At_2, At_3, At_4, and so on (e.g., identifying one or more attributes of Worker_1), among other examples. These features and feature values are provided as examples, and may differ in other examples.

A respective worker profile may be associated with a target variable 406. The target variable 406 may represent a variable having a numeric value, may represent a variable having a numeric value that falls within a range of values or has some discrete possible values, may represent a variable that is selectable from one of multiple options (e.g., one of multiple classes, classifications, or labels) and/or may represent a variable having a Boolean value. A target variable 406 may be associated with a target variable value, and a target variable value may be specific to a worker profile. As shown in FIG. 5, the target variable 406 is a device status (e.g., indicative of a pairing status of a robot 114 with the Worker_1), which has a value of Pair for the profile of the Worker_1. The feature set and target variable described above are provided as examples, and other examples may differ from what is described above.

The target variable 406 may represent a value that a machine learning model is being trained to predict, and the feature set 404 may represent the variables that are input to a trained machine learning model to predict a value for the target variable 406. The set of worker profiles 402 include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of worker profiles 402 that do not include a target variable. This may be referred to as an unsupervised learning model. In this case, the machine learning model may learn patterns from the set of worker profiles 402 without labeling or supervision, and may provide an output that indicates such patterns, such as by using clustering and/or association to identify related groups of workers 112 within the set of worker profiles 402.

The machine learning system may train a machine learning model 408 using the set of worker profiles 402 and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 410 to be used to analyze a new work profile and/or new sets of worker profiles 402.

The machine learning system may apply the trained machine learning model 410 to a new worker profile (e.g., New Worker_N), such as by receiving a new worker profile and inputting the new worker profile to the trained machine learning model 410. As shown in FIG. 5, a new worker profile may include a first feature of device information (e.g., Information_N), a second feature of task data (e.g., Task Set_N), a third feature of worker data (e.g., At_N.1, At_N.2, At_N.3, At_N.4), and so on, as an example. The machine learning system may apply the trained machine learning model 410 to the new worker profile to generate an output (e.g., a result). The type of output may depend on the type of machine learning model and/or the type of machine learning task being performed. For example, the output may include a predicted value of a target variable 406, such as when supervised learning is employed. Additionally, or alternatively, the output may include information that identifies a cluster to which the new worker profile belongs and/or information that indicates a degree of similarity between the new worker profile and one or more other worker profiles, such as when unsupervised learning is employed.

As an example, the trained machine learning model 410 may predict a value of Pair for the target variable 406 of the device status for the new worker profile of New Worker_N. Based on this prediction, the machine learning system may provide a first recommendation, may provide an output for determination of a first recommendation, may perform a first automated action, and/or may cause a first automated action to be performed, among other examples.

In some implementations, the trained machine learning model 410 may classify (e.g., cluster) the new worker profile in a cluster. The worker profiles within a cluster may have a threshold degree of similarity. As an example, if the machine learning system classifies the new worker profile in a first cluster 412-1 (e.g., a cluster associated with a status or a group of statuses), then the machine learning system may provide a first recommendation, such as the first recommendation described above. Additionally, or alternatively, the machine learning system may perform a first automated action and/or may cause a first automated action to be performed based on classifying the new worker profile in the first cluster, such as the first automated action described above. Other clusters may include cluster 412-2 and cluster 412-3, as shown in FIG. 5.

In some implementations, the recommendation and/or the automated action associated with the new worker profile may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified. The recommendations, actions, and clusters described above are provided as examples, and other examples may differ from what is described above.

In some implementations, the trained machine learning model 410 may be re-trained using feedback information. For example, feedback may be provided to the machine learning model. The feedback may be associated with actions performed based on the recommendations provided by the trained machine learning model 410 and/or automated actions performed, or caused, by the trained machine learning model 410. In other words, the recommendations and/or actions output by the trained machine learning model 410 may be used as inputs to re-train the machine learning model (e.g., a feedback loop may be used to train and/or update the machine learning model). For example, the feedback information may include updated worker data (e.g., one or more attributes of the worker data) associated with a worker profile.

In this way, the machine learning system may apply a rigorous and automated process to learn and identify statuses associated with a worker 112 (e.g., a pairing status with a robot 114). The machine learning system enables recognition and/or identification of tens, hundreds, thousands, or millions of features and/or feature values for tens, hundreds, thousands, or millions of observations, thereby increasing accuracy and consistency and reducing delay associated with identifying statuses and improvements for dynamically pairing a worker 112 and a robot 114. As indicated above, FIG. 5 is provided as an example. Other examples may differ from what is described in connection with FIG. 5.

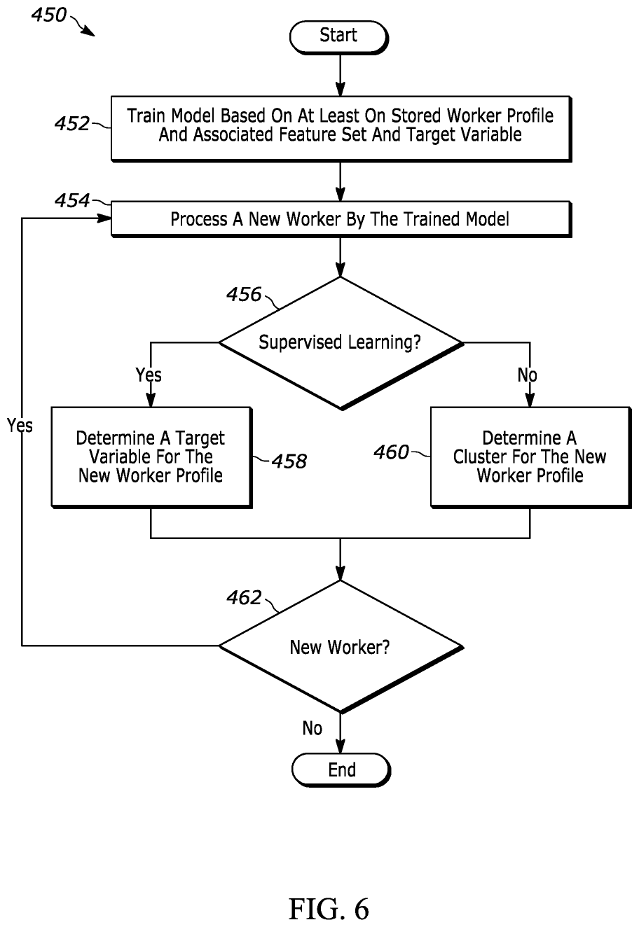

FIG. 6 is a flowchart illustrating processing steps 450 in relation to FIG. 5. In particular, FIG. 6 is a flowchart illustrating processing steps 450 associated with training and using a machine learning model. In some implementations, one or more processing steps of FIG. 6 may be performed by a system (e.g., the system 100). In some implementations, one or more processing steps of FIG. 6 may be performed by another device or a group of devices separate from or including the system 100, such as the computing device 122, the mobile device 118, or any other suitable device.

As shown in FIG. 6, in step 452, the system 100 trains a machine learning model based on at least one stored worker profile and associated feature set and target variable (e.g., a stored pairing of a workflow and robot 114 with a worker 112). Accordingly, the system 100 may train the machine learning model using one or more machine learning algorithms, such as a regression algorithm, a decision tree algorithm, a neural network algorithm, a k-nearest neighbor algorithm, a support vector machine algorithm, or the like. After training, the system 100 may store the machine learning model as a trained machine learning model to be utilized to analyze new workers and the profiles thereof.

In step 454, the system 100 processes a new worker by the trained model via processing steps 456-460. In step 456, the system 100 determines whether to utilize supervised learning. If the system 100 utilizes supervised learning then the process proceeds to step 458. In step 458, the trained model may predict a target variable for the new worker and profile thereof. Alternatively, if the system does not utilize supervised learning (e.g., the system 100 utilizes unsupervised learning), then the process proceeds to step 460. In step 460, the trained model may determine a cluster for the new worker and profile thereof.

In step 462, the system 100 determines whether a new worker is available. If a new worker is available, the process returns to step 454. As such, the process can iterate for each new worker to be processed. Accordingly, the trained model may be utilized repeatedly for new workers. Alternatively, if a new worker is not available, the process ends. In some implementations, as described in connection with FIG. 5, the model may be re-trained using outputs from some or all of the new workers.

FIG. 6 illustrates example processing steps. In some implementations, the process may include additional steps, fewer steps, different steps, or differently arranged steps than those depicted in FIG. 6. Additionally, or alternatively, two or more of the steps of the process may be performed in parallel.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed:

1. A system for pairing a device and an individual, comprising:
a memory configured to store computer executable instructions; and
a processor configured to interface with the memory and execute the computer executable instructions to cause the processor to:
receive first task data indicative of a first set of tasks to be executed by an individual among one or more individuals, device data indicative of identification information of a device, and data of the one or more individuals,
select at least one attribute of the data of the one or more individuals,
weight the selected at least one attribute of the data of the one or more individuals,
determine a profile and a profile value for each of the one or more individuals based on the weighted at least one attribute of the data of the one or more individuals, and
pair the first task data and the device with a first individual from among the one or more individuals based on the determined profile value for each of the one or more individuals.

2. The system of claim 1, wherein the processor
receives second task data indicative of a second set of tasks to be executed by an individual from among the one or more individuals, the device data indicative of the device, and the data of the one or more individuals,
selects the at least one attribute of the data of the one or more individuals,
weights the selected at least one attribute of the data of the one or more individuals,
updates the profile and the profile value for each of the one or more individuals based on the weighted at least one attribute of the data of the one or more individuals, and
pairs the second task data and the device with a second individual, different from the first individual, from among the one or more individuals based on the updated profile value for each of the one or more individuals.

3. The system of claim 2, wherein the processor
determines the profile and the profile value for each of the one or more individuals based on the weighted at least one attribute of the data of the one or more individuals before a commencement of a predetermined period, and
updates the profile and the profile value for each of the one or more individuals based on the weighted at least one attribute of the data of the one or more individuals during the predetermined period.

4. The system of claim 1, wherein the at least one attribute is one or more of a route distance of one or more completed sets of tasks, a total distance traveled during a predetermined time period, an average speed, a number of completed sets of tasks during the predetermined time period, a number of rest periods during the predetermined time period, a navigated elevation change, a work environment, and energy expenditure associated with the set of tasks.

5. The system of claim 1, wherein
the device is one of a robot, an autonomous mobile robot (AMR) and a drone, and
the device assists the first individual with executing the first task data indicative of the first set of tasks.

6. The system of claim 1, wherein the processor weights the selected at least one attribute of the data of the one or more individuals based on a predetermined coefficient.

7. The system of claim 1, wherein the processor pairs the first task data and the device with the first individual from among the one or more individuals based on a lowest determined profile value.

8. A method for pairing a device and an individual, comprising:
receiving first task data indicative of a first set of tasks to be executed by an individual among one or more individuals, device data indicative of identification information of a device, and data of the one or more individuals;
selecting at least one attribute of the data of the one or more individuals;
weighting the selected at least one attribute of the data of the one or more individuals;
determining a profile and a profile value for each of the one or more individuals based on the weighted at least one attribute of the data of the one or more individuals; and
pairing the first task data and the device with a first individual from among the one or more individuals based on the determined profile value for each of the one or more individuals.

9. The method of claim 8, further comprising:
receiving second task data indicative of a second set of tasks to be executed by an individual from among the one or more individuals, the device data indicative of identification information of the device, and the data of the one or more individuals;
selecting the at least one attribute of the data of the one or more individuals;
weighting the selected at least one attribute of the data of the one or more individuals;
updating the profile and the profile value for each of the one or more individuals based on the weighted at least one attribute of the data of the one or more individuals; and
pairing the second task data and the device with a second individual, different from the first individual, from among the one or more individuals based on the updated profile value for each of the one or more individuals.

10. The method of claim 9, further comprising
determining the profile and the profile value for each of the one or more individuals based on the weighted at least one attribute of the data of the one or more individuals before a commencement of a predetermined period, and
updating the profile and the profile value for each of the one or more individuals based on the weighted selected at least one attribute of the data of the one or more individuals during the predetermined period.

11. The method of claim 8, wherein the at least one attribute is one or more of a route distance of one or more completed sets of tasks, a total distance traveled during a predetermined time period, an average speed, a number of completed sets of tasks during the predetermined time period, a number of rest periods during the predetermined time period, a navigated elevation change, a work environment, and energy expenditure associated with the set of tasks.

12. The method of claim 8, wherein
the device is one of a robot, an autonomous mobile robot (AMR) and a drone, and
the device assists the first individual with executing the first task data indicative of the first set of tasks.

13. The method of claim 8, further comprising weighting the selected at least one attribute of the data of the one or more individuals based on a predetermined coefficient.

14. The method of claim 8, further comprising pairing the first task data and the device with the first individual from among the one or more individuals based on a lowest determined profile value.

15. A non-transitory computer readable medium having instructions stored thereon for pairing a device and an individual which, when executed by a processor, causes the processor to carry out the steps of:
receiving first task data indicative of a first set of tasks to be executed by an individual among one or more individuals, device data indicative of identification information of a device, and data of the one or more individuals;
selecting at least one attribute of the data of the one or more individuals;
weighting the selected at least one attribute of the data of the one or more individuals;
determining a profile and a profile value for each of the one or more individuals based on the weighted at least one attribute of the data of the one or more individuals; and
pairing the first task data and the device with a first individual from among the one or more individuals based on the determined profile value for each of the one or more individuals.

16. The non-transitory computer readable medium of claim 15, further comprising the steps of:
receiving second task data indicative of a second set of tasks to be executed by an individual from among the one or more individuals, the device data indicative of identification information of the device, and the data of the one or more individuals;
selecting the at least one attribute of the data of the one or more individuals;
weighting the selected at least one attribute of the data of the one or more individuals;
updating the profile and the profile value for each of the one or more individuals based on the weighted at least one attribute of the data of the one or more individuals; and
pairing the second task data and the device with a second individual, different from the first individual, from among the one or more individuals based on the updated profile value for each of the one or more individuals.

17. The non-transitory computer readable medium of claim 16, further comprising the steps of:
determining the profile and the profile value for each of the one or more individuals based on the weighted at least one attribute of the data of the one or more individuals before a commencement of a predetermined period, and
updating the profile and the profile value for each of the one or more individuals based on the weighted selected at least one attribute of the data of the one or more individuals during the predetermined period.

18. The non-transitory computer readable medium of claim 15, wherein the at least one attribute is one or more of a route distance of one or more completed sets of tasks, a total distance traveled during a predetermined time period, an average speed, a number of completed sets of tasks during the predetermined time period, a number of rest periods during the predetermined time period, a navigated elevation change, a work environment, and energy expenditure associated with the set of tasks.

19. The non-transitory computer readable medium of claim 15, wherein
the device is one of a robot, an autonomous mobile robot (AMR) and a drone, and
the device assists the first individual with executing the first task data indicative of the first set of tasks.

20. The non-transitory computer readable medium of claim 15, further comprising the step of pairing the first task data and the device with the first individual from among the one or more individuals based on a lowest determined profile value.
